(19) United States
(12) Patent Application Publication
(10) Pub. No.: US 2023/0007632 A1
(43) Pub. Date: Jan. 5, 2023

(54) CONFIGURING A SEARCH SPACE SET FOR DOWNLINK CONTROL INFORMATION

(71) Applicant: QUALCOMM Incorporated, San Diego, CA (US)

(72) Inventors: Yuwei REN, Beijing (CN); Huilin XU, Temecula, CA (US); Le LIU, San Jose, CA (US)

(21) Appl. No.: 17/757,203

(22) PCT Filed: Jan. 7, 2020
(86) PCT No.: PCT/CN2020/070625

§ 371 Date: Jun. 10, 2022

(51) Int. Cl. H04W 72/04; H04L 5/00

(52) U.S. Cl. CPC H04W 72/042; H04L 5/0023; H04L 5/0035; H04W 72/0446

(57) ABSTRACT

Wireless communications systems and methods related to configuring a search space set for the communication of downlink control information (DCI) are provided. A first wireless communication device communicates, with a second wireless communication device, a search space (SS) configuration, wherein the SS configuration includes a first search space for uplink scheduling and a second search space for downlink scheduling, the second search space being different than the first search space. The first wireless communication device communicates, with the second wireless communication device, a scheduling grant in one of the first search space or the second search space based on the SS configuration and further communicates data based on the scheduling grant.

### TECHNICAL FIELD

This application relates to wireless communication systems, including configuring a search space set for the communication of downlink control information (DCI).

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum. Additionally, NR-Lite or NR-Light technology can be designed to address cases such as internet of things (IoT) applications.

In a wireless communication network, a base station (BS) may transmit downlink control information (DCI) to user equipment (UE) on a downlink channel, where the DCI may be used to schedule the communication of uplink and downlink data. The UE may monitor a search space (SS), which includes physical resources such as time and frequency domain(s), in order to detect a downlink channel carrying DCI. In monitoring for DCI, a UE may be configured to search within time domain patterns, within common or UE-specific search space(s), and for various DCI formats.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication includes communicating, by a first wireless communication device with a second wireless communication device, a search space (SS) configuration, wherein the SS configuration includes a first search space for uplink scheduling and a second search space for downlink scheduling, the second search space being different than the first search space; communicating, by the first wireless communication device with the second wireless communication device, a scheduling grant in one of the first search space or the second search space based on the SS configuration; and communicating, by the first wireless communication device with the second wireless communication device, data based on the scheduling grant.

In an additional aspect of the disclosure, a method of wireless communication includes communicating, by a first wireless communication device with a second wireless communication device, a search space (SS) configuration, wherein the SS configuration includes a first search space that is configurable for either uplink scheduling or downlink scheduling, wherein the SS configuration further indicates the first search space is for one of uplink scheduling or downlink scheduling; communicating, by the first wireless communication device with the second wireless communication device, a scheduling grant in the first search space based on the SS configuration; and communicating, by the first wireless communication device with the second wireless communication device, data based on the scheduling grant.

In an additional aspect of the disclosure, a first wireless communication device includes a transceiver configured to: communicate, with a second wireless communication device, a search space (SS) configuration, wherein the SS configuration includes a first search space for uplink scheduling and a second search space for downlink scheduling, the second search space being different than the first search space; communicate, with the second wireless communication device, a scheduling grant in one of the first search space or the second search space based on the SS configuration; and communicate, with the second wireless communication device, data based on the scheduling grant.

In an additional aspect of the disclosure, a non-transitory computer-readable medium includes program code recorded thereon, the program code including code for causing a first wireless communication device to communicate, with a second wireless communication device, a search space (SS) configuration, wherein the SS configuration includes a first search space for uplink scheduling and a second search space for downlink scheduling, the second search space being different than the first search space; communicate, with the second wireless communication device, a scheduling grant in one of the first search space or the second search space based on the SS configuration; and communicate, with the second wireless communication device, data based on the scheduling grant.

In an additional aspect of the disclosure, a first wireless communication device includes means for communicating, with a second wireless communication device, a search space (SS) configuration, wherein the SS configuration includes a first search space for uplink scheduling and a second search space for downlink scheduling, the second search space being different than the first search space; means for communicating, with the second wireless communication device, a scheduling grant in one of the first search space or the second search space based on the SS configuration; and means for communicating, with the second wireless communication device, data based on the scheduling grant.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3 illustrates a search space configuration scheme according to some aspects of the present disclosure.

FIG. 4 illustrates a search space configuration scheme according to some aspects of the present disclosure.

FIG. 5 is a block diagram of a user equipment (UE) according to some aspects of the present disclosure.

FIG. 6 is a block diagram of an exemplary base station (BS) according to some aspects of the present disclosure.

FIG. 7 illustrates a search space configuration scheme according to some aspects of the present disclosure.

FIG. 8 illustrates a search space configuration scheme according to some aspects of the present disclosure.

FIG. 9 is a flow diagram of a communication method according to some aspects of the present disclosure.

FIG. 10 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜0.99.9999% reliability), ultra-low latency (e.g., −1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

In a wireless communication network, a UE may receive DCI transmitted from a BS on a downlink channel(s). DCI may be transmitted on a physical downlink channel, such as a physical downlink control channel (PDCCH). In some aspects, a UE may be configured to detect the transmission of PDCCH carrying DCI by monitoring a search space (SS), which can include certain downlink physical resources. For instance, a UE may be configured to search within certain resources in time and frequency domain(s).

A UE may be configured with parameters for monitoring a SS for DCI. In some aspects, a UE may be configured to search within a time domain pattern (e.g., time periods such as symbols), aggregation level (e.g., indicating the amount of physical resources allocated for a PDCCH), and number of candidates (e.g., number of PDCCH(s) that are candidates for carrying DCI). Further, one or more SSs may be configured within the frequency range of a CORESET that is configured for a UE. A UE may be further configured to search within a common search space (CSS) or a UE-specific search space (USS). A CSS may be a search space that a group of UEs or all UEs in a cell monitor to detect PDCCH carrying DCI such as scheduling information for system information blocks (SIBs). A CSS may also carry signaling messages and DCI used by a UE before dedicated channels are established (e.g., PDCCH received during random access, such as scheduling information for a random access response or scheduling grant). A USS may be dedicated to a specific UE and indicated to the UE in a radio resource control (RRC) signaling message. A UE may also be configured to search for various DCI formats, where DCI associated with one format may have a different size (e.g., number of bits) than DCI associated with another format. Further, a single search space may be configured to carry PDCCH having one or more DCI formats. A set of parameters for monitoring a SS may be referred to as a search space set (SS set), and UE may be configured with one or more SS sets.

In some aspects, a DCI format may be associated with scheduling an uplink data channel, such as a physical uplink shared channel (PUSCH). For instance, downlink DCI formats 0_0 and 0_1 may be associated with scheduling PUSCH in a cell. Format 0_0 may be a fallback format, supporting a limited set of features and using less overhead (e.g., used during a transition period when a UE is being configured for other features). Format 0_1 may be a non-fallback format, supporting more features configured for a UE (e.g., cross-carrier scheduling, BWP switching). Further, a DCI format may be associated with scheduling an downlink data channel. For instance, an DCI format may schedule a physical downlink shared channel (PDSCH), and fallback DCI format 1_0 and non-fallback DCI format 1_1 may be associated with scheduling PDSCH in a cell. In some aspects, DCI formats for scheduling PDSCH and PUSCH are as described in 3GPP Technical Specification (TS) 38.212 Release 15, titled “3^{rd} Generation Partnership Project; Technical Specification Group Radio Access Network; NR; Multiplexing and channel coding,” at Table 7.3.1-1, which is incorporated by reference herein.

In some aspects, a UE may monitor physical resources for PDCCH(s) carrying DCI(s) via a blind decoding procedure. For instance, a UE may determine PDCCH configuration information, such as the range or set of physical resources to monitor, based on the SS configuration and the CORESET. Within the range or set of physical resources and based on information in the SS configuration, a UE may apply different PDCCH configuration parameters (e.g., aggregation level (AL), number of PDCCH candidates per AL and/or per radio network temporary identifier (RNTI)) in order to determine the possible physical resource locations in which the PDCCH candidates may be transmitted. A UE may further apply an RNTI-based scrambling mask to each PDCCH candidate in order to detect DCI carried on a PDCCH via blind decoding.

To detect DCI, a UE may perform a blind decode in each configured SS. In some aspects, uplink and downlink fallback DCIs (e.g., DCI formats 0_0 and 1_0) may have matching sizes, such that monitoring a SS using a single blind decode can detect both uplink and downlink fallback DCIs. Fallback DCIs having matching sizes can be differentiated as either uplink or downlink DCI based on other information such as information provided in the DCI's contents. However, uplink and downlink non-fallback DCIs (e.g., DCI formats 0_1 and 1_1) may not be size matched, such that separate blind decodes are to be used to detect each of uplink non-fallback DCI formats and downlink non-fallback DCI formats.

In a wireless communication network, a single SS can be configured to include PDCCHs carrying DCIs for scheduling both uplink channels (e.g., DCI format 0_1) and downlink channels (e.g., DCI format 1_1). For such a SS that can include both uplink and downlink DCIs, a UE may use separate blind decodes to detect each of the non-size-matched uplink and downlink DCIs. A UE may also be configured to support unbalanced uplink and downlink data traffic, such that DCI formats for scheduling uplink data may be monitored more frequently than DCI formats for scheduling downlink data (or vice versa). For instance, a UE may be configured to transmit PUSCH data more frequently than it receives PDSCH data, and as a result, a UE may monitor a DCI format(s) for scheduling uplink data (e.g., DCI format 0_1) more frequently than DCI format(s) for scheduling downlink data (e.g., DCI format 1_1). In some aspects, a UE may comprise a video surveillance device that frequently transmits uplink video data and thus more frequently monitors a DCI format(s) for scheduling uplink data compared to a DCI format(s) for scheduling downlink data. Alternatively, a UE may be configured to receive PDSCH data more frequently than it transmits PUSCH data, and such a UE may monitor a DCI format(s) for scheduling downlink data (e.g., DCI format 1_1) more frequently than DCI format(s) for scheduling uplink data (e.g., DCI format 0_1).

For a single search space configured to include both uplink and downlink DCI formats, a UE is to perform a blind decode to search for uplink DCI as well as a blind decode to search for downlink DCI, causing the UE to perform an unnecessarily large number of blind decodes. For instance, a UE may perform unnecessary blind decodes when traffic in one direction is not as frequent (e.g., a DCI format for scheduling downlink data is detected infrequently) as traffic in the reverse link direction (e.g., a DCI format for scheduling uplink data is detected frequently). By comparison, configuring a search space to include only one of either an uplink DCI format or a downlink DCI format may allow a UE to avoid performing unnecessary blind decodes.

Accordingly, aspects of the present disclosure are directed to communicating, by a first wireless communication device with a second wireless communication device, a SS configuration including a first search space for uplink scheduling and a second search space for downlink scheduling, the second search space being different than the first search space. For instance, the first wireless communication device and a second wireless communication device can communicate a scheduling grant in one of the first search space or the second search space based on the SS configuration. Further, the first wireless communication device and a second wireless communication device can communicate data based on the scheduling grant, such as the first wireless communication device transmitting PDSCH data or the second wireless communication device transmitting PUSCH data.

In some aspects, a SS configuration can include a UE-specific search space (USS) configuration, where the USS configuration includes a first field value indicating a first search space is configured for uplink scheduling and a second field value indicating a second search space is configured for downlink scheduling. In some aspects, a SS configuration can include a field, the field including a first field value indicating a first search space is configured for uplink scheduling or a second field value indicating a second search space is configured for downlink scheduling. Further, a first search space can be configured for downlink control information (DCI) format 0_1 and a second search space can be configured for DCI format 1_1.

In some aspects, the present disclosure is directed to communicating, by a first wireless communication device with a second wireless communication device, a SS configuration including a first search space that is configurable for either uplink scheduling or downlink scheduling, wherein the SS configuration further indicates the first search space is for one of uplink scheduling or downlink scheduling. For instance, a media access control (MAC) control element (CE), a RRC message, or a PDCCH in a CSS can indicate that a first search space is for one of uplink scheduling or downlink scheduling. Further, a wireless communication device may determine the first search space is for one of uplink scheduling or downlink scheduling based on a rule or an aggregation level configuration. In some aspects, the first search space can be configured for one of DCI format 0_1 or DCI format 1_1.

Aspects of the present disclosure can provide several benefits. For example, a SS configuration that includes DCI formats for scheduling both downlink and uplink data may require separate blind decodes by a UE to detect each of the non-size-matched uplink and downlink DCIs, which can result in unnecessary blind decodes when a UE has unbalanced uplink versus downlink traffic, as discussed above. By comparison, the present disclosure includes configuring a search space to include either an uplink DCI format or a downlink DCI format, or configuring an uplink DCI format in a first search space and configuring a downlink DCI format in a second search space, such that a UE may blind decode a SS for either an uplink DCI format or a downlink DCI format when monitoring the SS for DCI. The present disclosure thus beneficially allows a UE to perform fewer overall blind decodes compared to configuring uplink and downlink DCI formats in the same search space. Additionally, by reducing the number of blind decodes, the present disclosure beneficially provides a network with UEs having improved search-space monitoring and blind decoding efficiencies, while also freeing the UEs' resources for saving power or performing other functions. Further, the present disclosure beneficially includes configuring a SS for an uplink DCI format only, which can beneficially improve monitoring of an uplink DCI format for a UE with unbalanced uplink versus downlink traffic. The present disclosure therefore improves UE and network performance as to search space configuration and monitoring, beneficially providing higher data rates, higher capacity, better spectral efficiency, and increased reliability.

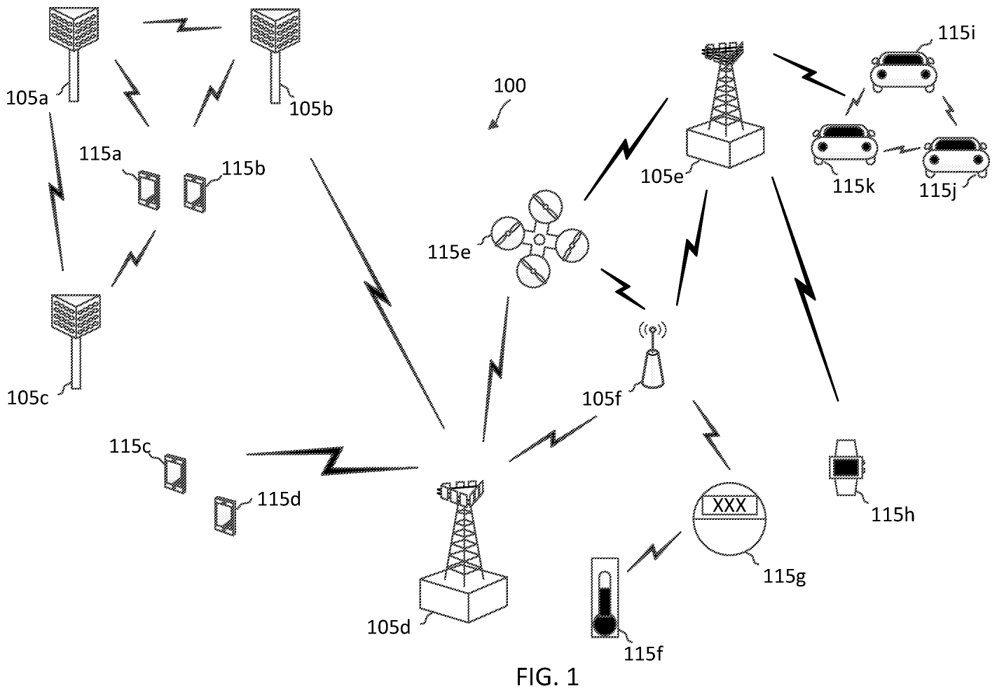

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 1050 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such asV2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

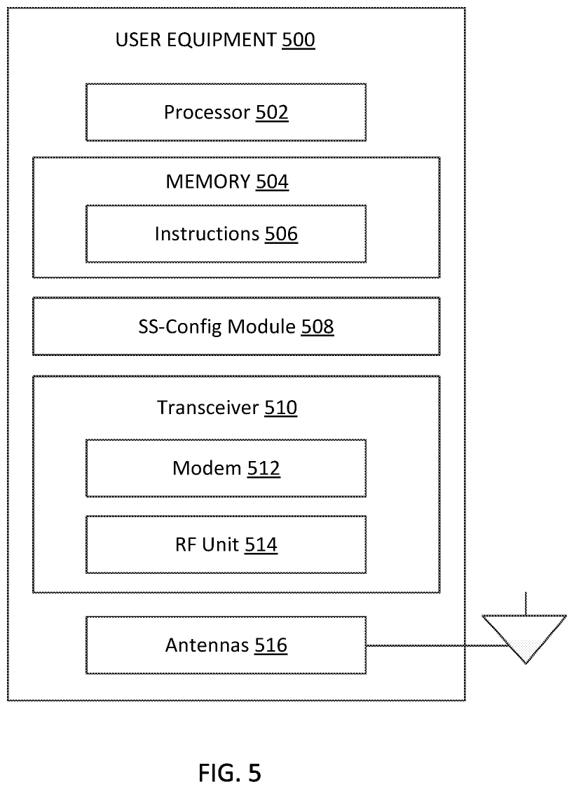

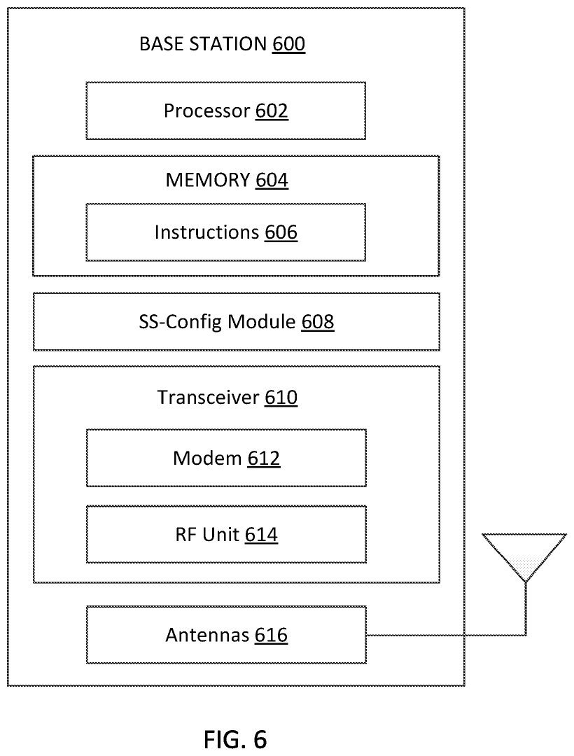

In some aspects, the network 100 may communicate DCI to UEs on downlink channels, such as PDCCHs. For instance, BS 105 (or BS 600 discussed below at FIG. 6) may transmit PDCCHs carrying DCI to UE 115 (or UE 500 discussed below at FIG. 5). Network 100 may configure PDCCH in one or more SSs monitored by UE 115 via blind decoding. UE 115 may monitor certain downlink physical resources (e.g., time and frequency domain(s)) for PDCCH transmitted by BS 105. In some aspects, network 100 may use the PDCCH carrying DCI in order to schedule PDSCH and PUSCH in a cell for UE 115 and BS 105 to communicate data.

In some aspects, network 100 may configure UE 115 to monitor a SS(s) according to SS set configuration(s) including set(s) of parameters. For instance, UE 115 may be configured to search one or more SSs according to time domain patterns (e.g., time periods or monitoring occasions, which may be periodically recurring), ALs, numbers of PDCCH candidates, and DCI formats, among other parameters, that may be configured by network 100. Network 100 may configure the UE 115 with one or more SSs, which may include CSS and USS. Network 100 may also configure certain DCI formats (e.g., uplink formats 0_0 and 0_1, downlink formats 1_0 and 1_1) in certain SSs, such as a CSS or USS. Network 100 may also configure one or more DCI formats within a single SS. In some aspects, network 100 may communicate SS configurations to UEs 115 via one or more messages transmitted by BS 105. For instance, BS 105 may transmit SS configuration information to UE 115 via a MAC CE, a RRC message, or a PDCCH in a CSS. Further, network 100 may configure a SS for an uplink and/or downlink DCI format(s) based on a rule or AL configuration.

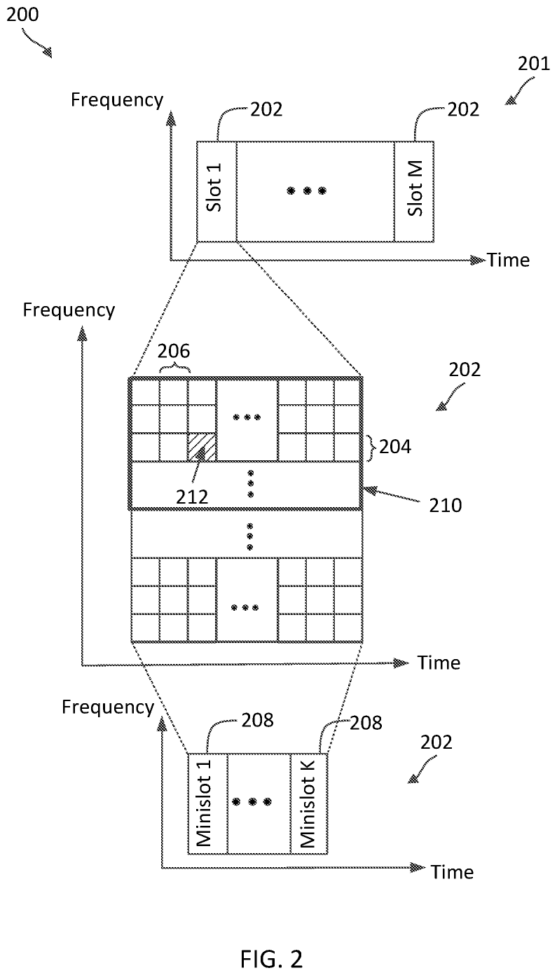

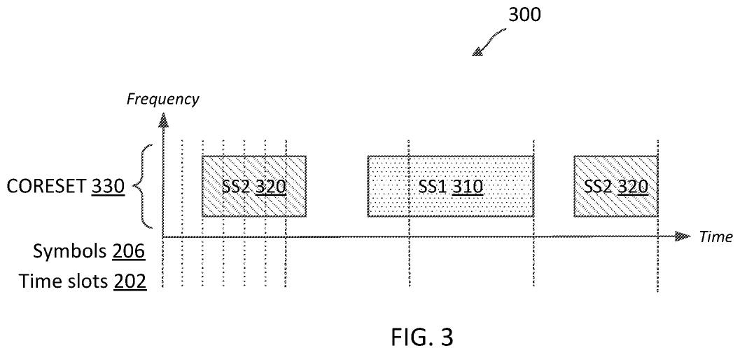

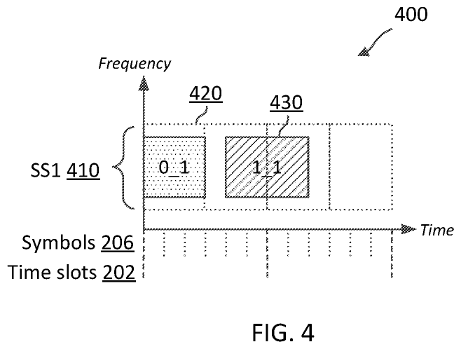

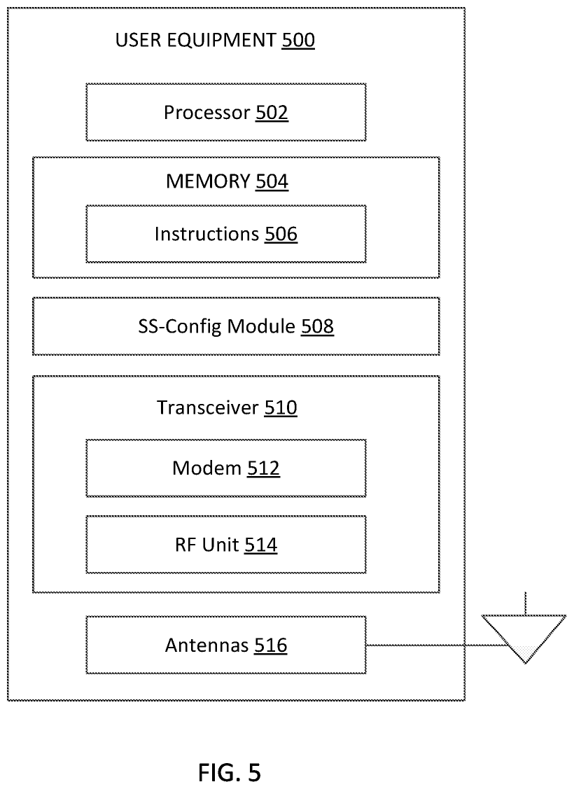

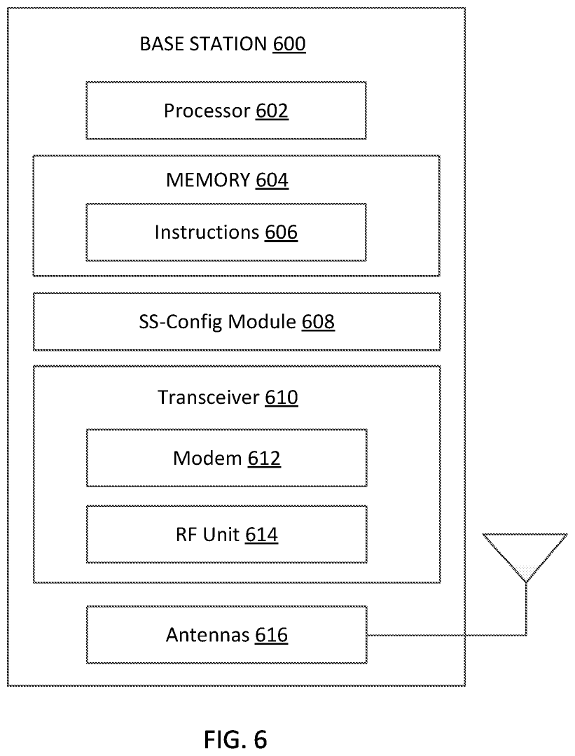

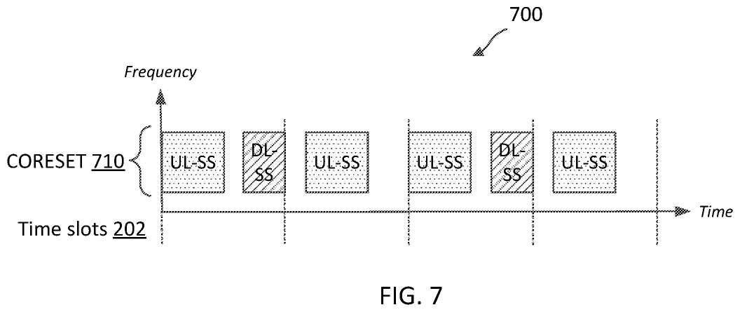

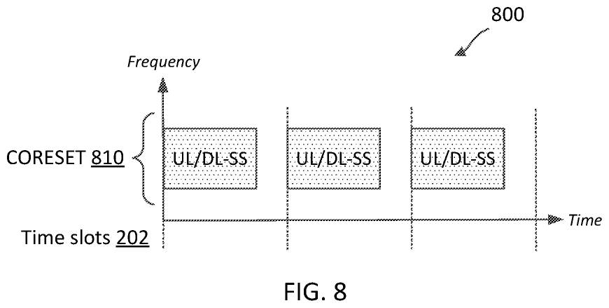

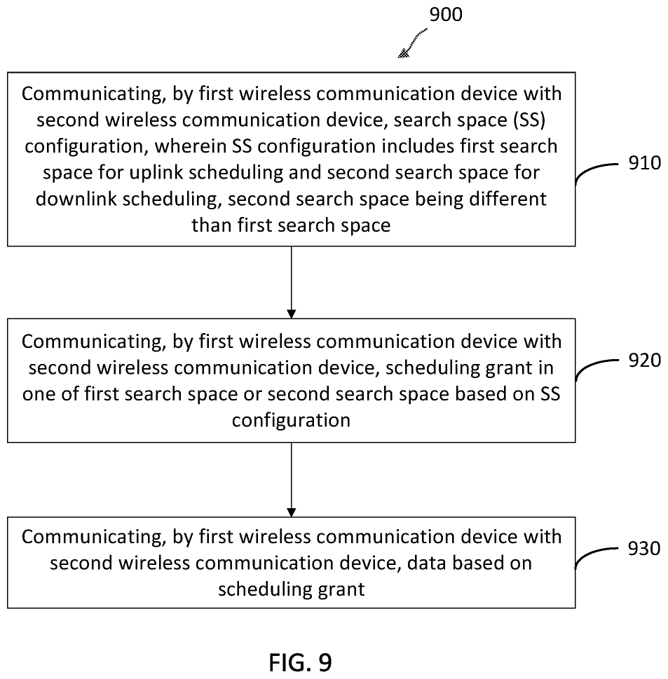

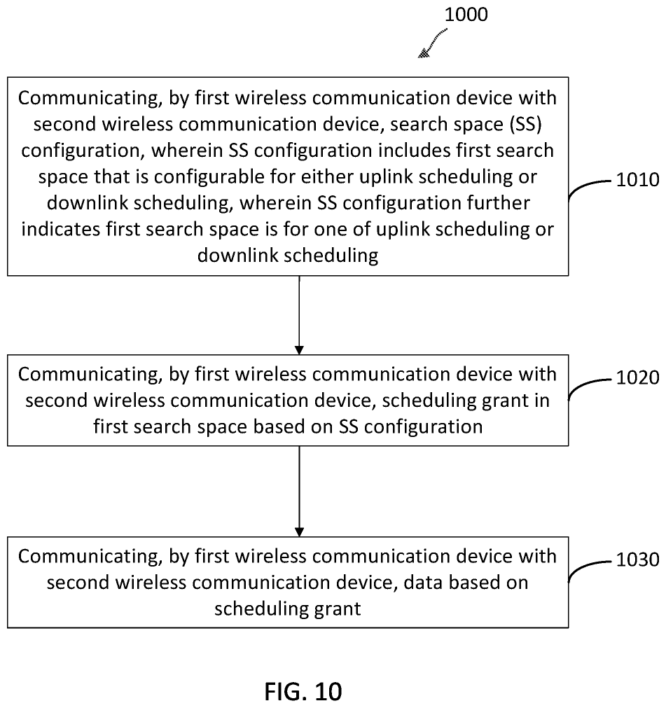

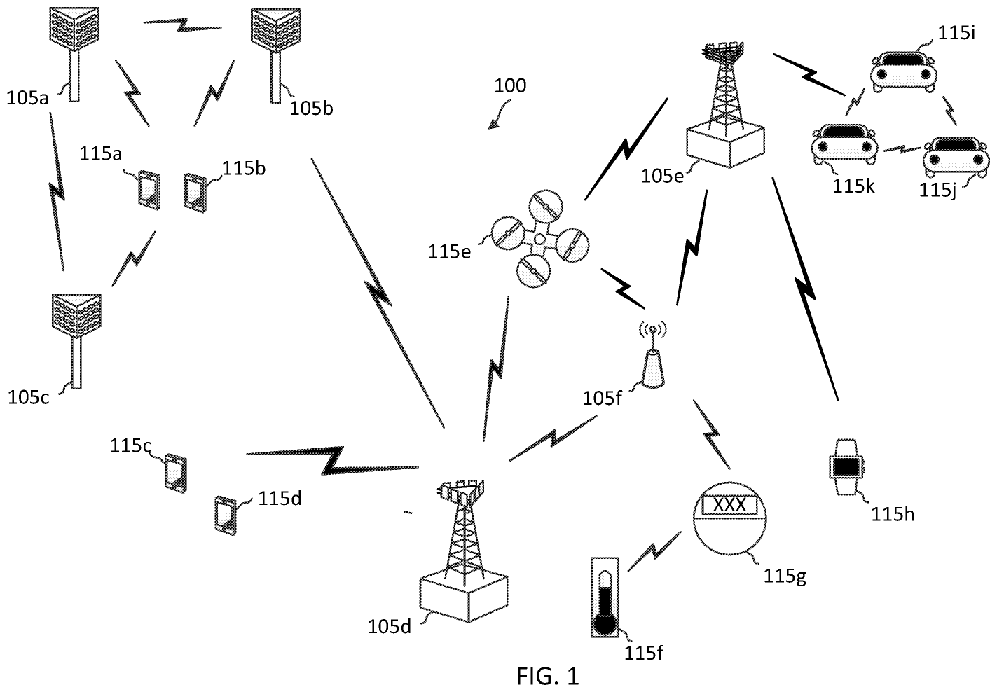

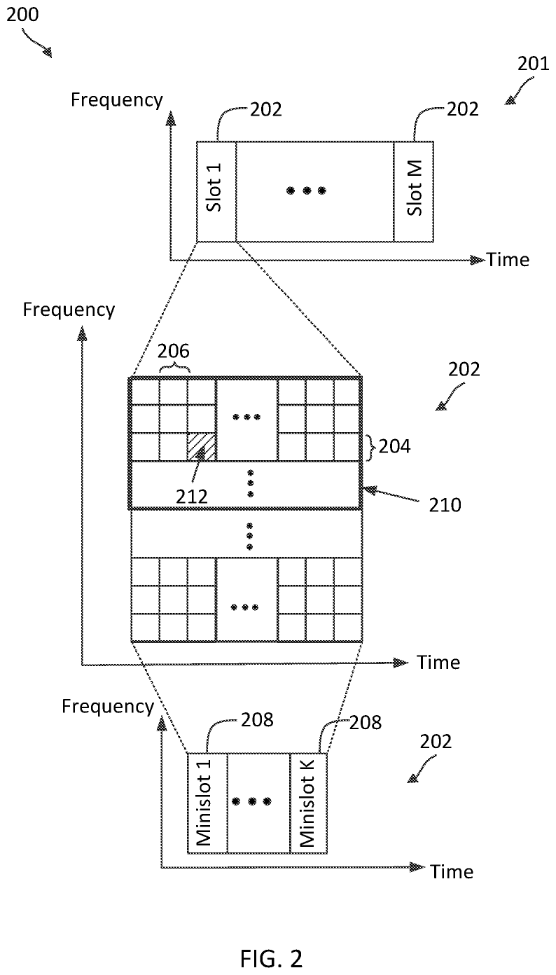

FIG. 2 is a timing diagram illustrating a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The transmission frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In an example, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

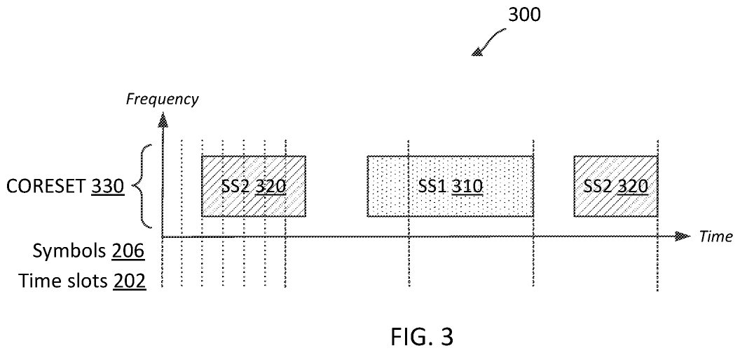

FIG. 3 illustrates a search space configuration scheme according to some aspects of the present disclosure. The functionality of scheme 300 can be executed by a computing device (e.g., a processor, processing circuit, and/or other suitable component) of a wireless communication device or other suitable means. In some aspects, a wireless communication device such as the UE 115 or UE 500 of FIG. 5 may utilize one or more components, such as the processor 502, the memory 404, the SS-Config module 508, the transceiver 510, the modem 512, and the one or more antennas 516, to execute the steps of scheme 300. Further, a wireless communication device such as the base station (BS) 105 or BS 600 of FIG. 6 may utilize one or more components, such as the processor 602, the memory 604, the SS-Config module 608, the transceiver 610, the modem 612, and the one or more antennas 616, to execute the steps of scheme 300. The scheme 300 may employ similar mechanisms as described in FIGS. 1-2 and 4-10. In FIG. 3, the x-axis represents time in some arbitrary units, and the y-axis represents frequency in some arbitrary units.

As illustrated in FIG. 3, multiple search spaces may be configured for a UE within time and frequency resources. In some aspects, a UE may monitor a search space within a range of frequency resources, such as within a CORESET, for a duration of symbols 206 within time slots 202. For instance, as illustrated in FIG. 3, two search spaces SS1 310 and SS2 320 may be configured within the frequency domain of a CORESET 330.

In some aspects, each search space illustrated in FIG. 3 may be associated with one or more DCI formats. For instance, a search space may be associated with a DCI format for downlink scheduling, or a search space may be associated with DCI formats for both downlink and uplink scheduling, as set forth 3GPP TS 38.212 Release 15. For instance, SS1 310 may be configured for PDCCH carrying DCI having DCI formats 0_1 (uplink) and DCI format 1_1 (downlink), and SS2 320 may be configured for DCI format 2_0 (downlink).

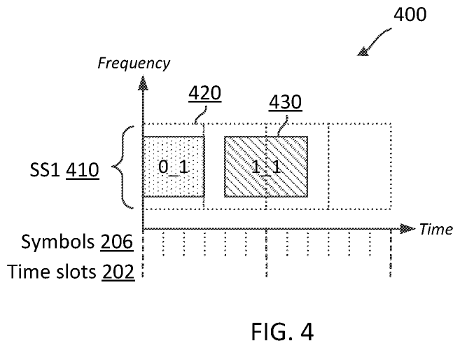

FIG. 4 illustrates a search space configuration scheme according to some aspects of the present disclosure. The functionality of scheme 400 can be executed by a computing device (e.g., a processor, processing circuit, and/or other suitable component) of a wireless communication device or other suitable means. In some aspects, a wireless communication device such as the UE 115 or UE 500 of FIG. 5 may utilize one or more components, such as the processor 502, the memory 404, the SS-Config module 508, the transceiver 510, the modem 512, and the one or more antennas 516, to execute the steps of scheme 400. Further, a wireless communication device such as the base station (BS) 105 or BS 600 of FIG. 6 may utilize one or more components, such as the processor 602, the memory 604, the SS-Config module 608, the transceiver 610, the modem 612, and the one or more antennas 616, to execute the steps of scheme 400. The scheme 400 may employ similar mechanisms as described in FIGS. 1-3 and 5-10. In FIG. 4, the x-axis represents time in some arbitrary units, and the y-axis represents frequency in some arbitrary units.

As illustrated in FIG. 4, multiple DCI formats may be configured within a single search space. For instance, DCI formats 0_1 and 1_1 may be both configured within a search space SS1 410. In some aspects, the size of PDCCH carrying DCI format 0_1 may be different than the size of PDCCH carrying DCI format 1_1; that is, DCIs of formats 0_1 and 1_1 may not be size matched. For instance, as illustrated in FIG. 4, the size of DCI having DCI format 0_1 may be three symbols whereas the size of DCI having format 1_1 may be four symbols.

In some aspects, in order to detect PDCCH carrying DCI within a search space, a UE may perform a blind decode. For instance, in order to detect DCI format 0_1, a UE may attempt to blind decode by searching for PDCCH that is three symbols long, as illustrated in FIG. 4 by blind decode attempt 420 (dotted boxes); therefore, a UE performing blind decode attempt 420 may then detect DCI format 0_1, which is illustrated as having the same size as the blind decode attempt 420 (i.e., three symbols long). However, a blind decode attempt that is size matched to DCI format 0_1 may not be size matched to DCI format 1_1. For instance, as illustrated in FIG. 4, DCI format 1_1 430 is four symbols long and does not fit within blind decode attempt 420, which searches for DCI that is three symbols long. As a result, blind decode attempt 420 may not detect DCI format 1_1 within SS1 410. Accordingly, in order to detect DCI formats 0_1 and 1_1 within SS1, a UE may perform two separate blind decodes that monitor for DCI having different sizes—e.g., one blind decode for DCI format 0_1 and another blind decode for DCI format 1_1—which increases decoding complexity for the UE. Further, in some aspects, the network may transmit DCI format 0_1 more often than DCI format 1_1 (or vice versa); as a result, in most instances, SS1 may carry DCI format 0_1 only, such that a UE performing separate blind decodes in SS1 configured for both DCI formats 0_1 and 1_1 may perform several unnecessary blind decode attempts for DCI format 1_1.

Accordingly, the present disclosure provides techniques for configuring a SS to include only one of an uplink DCI format or a downlink DCI format, or configuring an uplink DCI format in a first SS and configuring a downlink DCI format in a second SS. The present disclosure thereby allows a UE to blind decode a SS to monitor for an uplink DCI format or to blind decode a SS to monitor for an downlink DCI format. In some aspects, the present disclosure further provides techniques for communicating SS configuration information via a field, field value, MAC CE, RRC message, PDCCH in a CSS, rule, or AL configuration.

FIG. 5 is a block diagram of an exemplary UE 500 according to some aspects of the present disclosure. The UE 500 may be a UE 115 discussed above in FIG. 1. As shown, the UE 500 may include a processor 502, a memory 504, a SS-Config module 508, a transceiver 510 including a modem subsystem 512 and a radio frequency (RF) unit 514, and one or more antennas 516. These elements may be in direct or indirect communication with each other, for example via one or more buses.

The processor 502 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 504 includes a non-transitory computer-readable medium. The memory 504 may store, or have recorded thereon, instructions 506. The instructions 506 may include instructions that, when executed by the processor 502, cause the processor 502 to perform the operations described herein with reference to the UEs 115 in connection with aspects of the present disclosure, for example, aspects of FIGS. 3-4 and 7-10. Instructions 506 may also be referred to as program code. The program code may be for causing a wireless communication device to perform these operations, for example by causing one or more processors (such as processor 502) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The SS-Config module 508 may be implemented via hardware, software, or combinations thereof. For example, SS-Config module 508 may be implemented as a processor, circuit, and/or instructions 506 stored in the memory 504 and executed by the processor 502. In some examples, the SS-Config module 508 can be integrated within the modem subsystem 512. For example, the SS-Config module 508 can be implemented by a combination of software components (e.g., executed by a DSP or a general processor) and hardware components (e.g., logic gates and circuitry) within the modem subsystem 512. In some examples, a UE may include one or more SS-Config module 508.

The SS-Config module 508 may be used for various aspects of the present disclosure, for example, aspects of FIGS. 3-4 and 7-10. In some aspects, the SS-Config module 508 can be configured to monitor physical resources for PDCCH carrying DCI. In some aspects, this module is further configured to monitor one or more SS(s) according to SS configuration information, including a DCI format(s). In some aspects, this module is further configured to determine SS configuration information, including via communication with the network or a BS (e.g., BS 105 or BS 600) and/or based on information such as received parameters, fields, field values, MAC CE(s), RRC message(s), PDCCH(s) in CSS, or via rules or AL configurations. In some aspects, this module is further configured to monitor for both uplink and downlink DCI formats in the same SS. In some aspects, this module is further configured to monitor for one of a uplink or downlink DCI format within a SS. In some aspects, this module is further configured to schedule and communicate PUSCH and PDSCH data based on DCI detected in one or more SS.

As shown, the transceiver 510 may include the modem subsystem 512 and the RF unit 514. The transceiver 510 can be configured to communicate bi-directionally with other devices, such as the BSs 105. The modem subsystem 512 may be configured to modulate and/or encode the data from the memory 504 and/or the configured transmission module 507 according to a modulation and coding scheme (MCS), e.g., a low-density parity check (LDPC) coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data (e.g., configured UL transmissions, PUSCH, PUCCH, PRACH, SRS) from the modem subsystem 512 (on outbound transmissions) or of transmissions originating from another source such as a UE 115 or a BS 105. The RF unit 514 may be further configured to perform analog beamforming in conjunction with the digital beamforming. Although shown as integrated together in transceiver 510, the modem subsystem 512 and the RF unit 514 may be separate devices that are coupled together at the UE 115 to enable the UE 115 to communicate with other devices.

The RF unit 514 may provide the modulated and/or processed data, e.g. data packets (or, more generally, data messages that may contain one or more data packets and other information), to the antennas 516 for transmission to one or more other devices. The antennas 516 may further receive data messages transmitted from other devices. The antennas 516 may provide the received data messages for processing and/or demodulation at the transceiver 510. The transceiver 510 may provide the demodulated and decoded data (e.g., PDCCH, PDSCH, DCI, CORESETs, time domain resource allocation (TDRA) tables, downlink reference signals, PUSCH information, SS configuration information, MAC CE, RRC messages, fields, field values, other system and channel parameters) to the configured transmission module 507 for processing. The antennas 516 may include multiple antennas of similar or different designs in order to sustain multiple transmission links. The RF unit 514 may configure the antennas 516.

In an example, the transceiver 510 is configured to receive, from a base station (BS), information used in determining a SS configuration and further receive, from the BS, PDCCH carrying DCI based on SS configuration information, for example, by coordinating with the SS-Config module 508. The transceiver 510 may also be configured to communicate, with a BS, PUSCH or PDSCH scheduled via DCI, for example, by coordinating with the SS-Config module 508.

In an aspect, the UE 500 can include multiple transceivers 510 implementing different RATs (e.g., NR and LTE). In an aspect, the UE 500 can include a single transceiver 510 implementing multiple RATs (e.g., NR and LTE). In an aspect, the transceiver 510 can include various components, where different combinations of components can implement different RATs.

FIG. 6 is a block diagram of an exemplary BS 600 according to some aspects of the present disclosure. The BS 600 may be a BS 105 in the network 100 as discussed above in FIG. 1. A shown, the BS 600 may include a processor 602, a memory 604, SS-Config module 608, a transceiver 610 including a modem subsystem 612 and a RF unit 614, and one or more antennas 616. These elements may be in direct or indirect communication with each other, for example via one or more buses.

The processor 602 may have various features as a specific-type processor. For example, these may include a CPU, a DSP, an ASIC, a controller, a FPGA device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 604 may include a non-transitory computer-readable medium. The memory 604 may store instructions 606. The instructions 606 may include instructions that, when executed by the processor 602, cause the processor 602 to perform operations described herein, for example, aspects of FIGS. 3-4 and 7-10. Instructions 606 may also be referred to as code, which may be interpreted broadly to include any type of computer-readable statement(s) as discussed above with respect to FIG. 5.

The SS-Config module 608 may be implemented via hardware, software, or combinations thereof. For example, the SS-Config module 608 may be implemented as a processor, circuit, and/or instructions 606 stored in the memory 604 and executed by the processor 602. In some examples, the SS-Config module 608 can be integrated within the modem subsystem 612. For example, the SS-Config module 608 can be implemented by a combination of software components (e.g., executed by a DSP or a general processor) and hardware components (e.g., logic gates and circuitry) within the modem subsystem 612. In some examples, a UE may include one or more SS-Config module 608.

The SS-Config module 608 may be used for various aspects of the present disclosure, for example, aspects of FIGS. 3-4 and 7-10. In some aspects, the SS-Config module 608 can be configured to configure and communicate SS configuration information with a UE, including SS configuration information transmitted via system information, MAC CE(s), RRC message(s), and/or PDCCH(s) in CSS. In some aspects, this module may be configured to determine SS configuration information based on a rule or AL configuration. In some aspects, this module may be configured to configure and transmit PDCCHs carrying DCI within one or more SSs configured for a UE. In some aspects, this module may be configured to configure one or more DCI formats, including uplink and/or downlink DCI formats, within a single SS. In some aspects, this module may be configured to configure and communicate PUSCH and PDSCH data based on PDCCHs carrying DCI.

As shown, the transceiver 610 may include the modem subsystem 612 and the RF unit 614. The transceiver 610 can be configured to communicate bi-directionally with other devices, such as the UEs 115 and/or 500 and/or another core network element. The modem subsystem 612 may be configured to modulate and/or encode data according to a MCS, e.g., a LDPC coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data (e.g., PDCCH, PDSCH, DCI, CORESETs, time domain resource allocation (TDRA) tables, downlink reference signals, PUSCH information, SS configuration information, MAC CE, RRC messages, fields, field values, other system and channel parameters) from the modem subsystem 612 (on outbound transmissions) or of transmissions originating from another source such as a UE 115 and/or UE 500. The RF unit 614 may be further configured to perform analog beamforming in conjunction with the digital beamforming. Although shown as integrated together in transceiver 610, the modem subsystem 612 and/or the RF unit 614 may be separate devices that are coupled together at the BS 105 to enable the BS 105 to communicate with other devices.

The RF unit 614 may provide the modulated and/or processed data, e.g. data packets (or, more generally, data messages that may contain one or more data packets and other information), to the antennas 616 for transmission to one or more other devices. This may include, for example, transmission of information to complete attachment to a network and communication with a camped UE 115 or 500 according to some aspects of the present disclosure. The antennas 616 may further receive data messages transmitted from other devices and provide the received data messages for processing and/or demodulation at the transceiver 610. The transceiver 610 may provide the demodulated and decoded data (e.g., configured UL transmissions, PUSCH, PUCCH, PRACH, SRS) to the communication module 608 and configured transmission module 608 for processing. The antennas 616 may include multiple antennas of similar or different designs in order to sustain multiple transmission links.

In an example, the transceiver 610 is configured to transmit, to a UE, information used in determining a SS configuration and further transmit, to the UE, PDCCH carrying DCI based on SS configuration information, for example, by coordinating with the SS-Config module 608. The transceiver 610 may also be configured to communicate, with a UE, PUSCH or PDSCH scheduled via DCI, for example, by coordinating the SS-Config module 608.

In an aspect, the BS 600 can include multiple transceivers 610 implementing different RATs (e.g., NR and LTE). In an aspect, the BS 600 can include a single transceiver 610 implementing multiple RATs (e.g., NR and LTE). In an aspect, the transceiver 610 can include various components, where different combinations of components can implement different RATs.

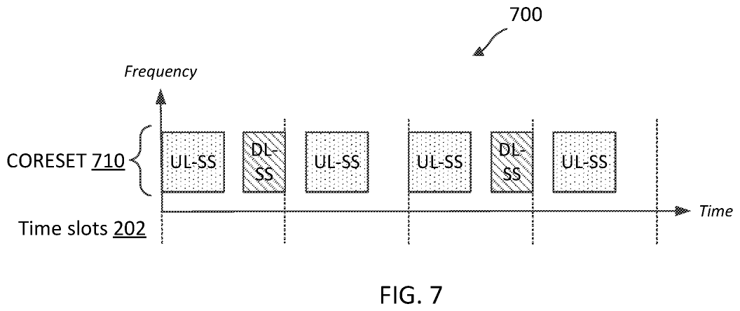

FIG. 7 illustrates a search space configuration scheme according to some aspects of the present disclosure. The functionality of scheme 700 can be executed by a computing device (e.g., a processor, processing circuit, and/or other suitable component) of a wireless communication device or other suitable means. In some aspects, a wireless communication device such as the UE 115 or UE 500 of FIG. 5 may utilize one or more components, such as the processor 502, the memory 404, the SS-Config module 508, the transceiver 510, the modem 512, and the one or more antennas 516, to execute the steps of scheme 700. Further, a wireless communication device such as the base station (BS) 105 or BS 600 of FIG. 6 may utilize one or more components, such as the processor 602, the memory 604, the SS-Config module 608, the transceiver 610, the modem 612, and the one or more antennas 616, to execute the steps of scheme 700. The scheme 700 may employ similar mechanisms as described in FIGS. 1-6 and 8-10. In FIG. 7, the x-axis represents time in some arbitrary units, and the y-axis represents frequency in some arbitrary units.

As illustrated in FIG. 7, a DCI format for scheduling uplink data may be configured in a separate search space from a DCI format for scheduling downlink data. For instance, two different search spaces, illustrated in FIG. 7 as UL-SS and DL-SS, may be configured within the frequency domain of a CORESET 710. A first search space, UL-SS, may be configured for scheduling uplink data; that is, UL-SS may be configured for a single DCI format, such as DCI format 0_1, for scheduling PUSCH data. Further, a second search space, DL-SS, may be configured for scheduling downlink data; that is DL-SS may be configured for a single DCI format, such as DCI format 1_1, for scheduling PDSCH data. In some aspects, UL-SS may be configured for scheduling uplink data whereas DL-SS may be configured for scheduling both uplink and downlink data; for instance, UL-SS may be configured for a DCI format for scheduling uplink data, whereas DL-SS may be configured for DCI formats 0_1 and 1_1 (or DCI formats 0_0 and 1_0).

In some aspects, a search space such as UL-SS or DL-SS of FIG. 7 may be associated with a search space identifier (SS ID). Each new or additional search space configured by the network may be associated with a new SS ID. For instance, a new search space configured only for uplink scheduling such as UL-SS may be associated with a new SS ID. The network may configure one or more SSs, such as those illustrated in FIGS. 3-4 and 7-8, by communicating a SS configuration to a UE, where the SS configuration includes an SS ID associated with each SS that is configured for a UE.

In some aspects, a SS configuration may include field values, including a first field value for indicating that a first search space is configured for uplink scheduling and a second field value for indicating that a second search space is configured for downlink scheduling. For instance, the first field value may indicate that the first search space is configured for DCI format 0_1 and the second field value may indicate that the second search space is configured for DCI format 1_1. In some aspects, a SS configuration may include a field, where the field includes including a first field value for indicating that a first search space is configured for uplink scheduling and a second field value for indicating that a second search space is configured for downlink scheduling. Alternatively, the field may include a third field value for indicating that the second search space is configured for both uplink and downlink scheduling (e.g., both DCI formats 0_1 and 1_1 as illustrated in FIG. 4).

As illustrated in FIG. 7, a UE may monitor a first search space (e.g., UL-SS) more often than a second search space (e.g., DL-SS). For instance, as illustrated in FIG. 7, UE may be a video surveillance device that receives PDCCH carrying DCI format 0_1 for scheduling the transmission of uplink video data more often than it receives PDCCH carrying DCI format 1_1 for scheduling the receipt of downlink data. As a result, for such a UE with unbalanced uplink versus downlink traffic, the UE may monitor UL-SS twice as often than it monitors DL-SS and thus may perform blind decode attempts for UL-SS more often than that for DL-SS (alternatively, a UE may have unbalanced traffic such that it monitors DL-SS more often than UL-SS). Therefore, the approach illustrated in FIG. 7 may more efficiently utilize a UE's blind decoding resources (e.g., processing power) than the scenario where both uplink and downlink DCI formats are configured within the same search space, which, as discussed above with respect to FIG. 4, would result in unnecessary blind decodes for the less frequent downlink DCI format 1_1.

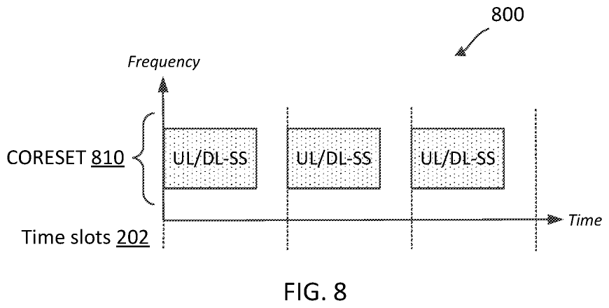

FIG. 8 illustrates a search space configuration scheme according to some aspects of the present disclosure. The functionality of scheme 800 can be executed by a computing device (e.g., a processor, processing circuit, and/or other suitable component) of a wireless communication device or other suitable means. In some aspects, a wireless communication device such as the UE 115 or UE 500 of FIG. 5 may utilize one or more components, such as the processor 502, the memory 404, the SS-Config module 508, the transceiver 510, the modem 512, and the one or more antennas 516, to execute the steps of scheme 800. Further, a wireless communication device such as the base station (BS) 105 or BS 600 of FIG. 6 may utilize one or more components, such as the processor 602, the memory 604, the SS-Config module 608, the transceiver 610, the modem 612, and the one or more antennas 616, to execute the steps of scheme 800. The scheme 800 may employ similar mechanisms as described in FIGS. 1-7 and 9-10. In FIG. 8, the x-axis represents time in some arbitrary units, and the y-axis represents frequency in some arbitrary units.

As illustrated in FIG. 8, a search space may be configurable for either uplink scheduling or downlink scheduling, and a UE may receive a SS configuration that indicates whether the search space is for one of uplink scheduling or downlink scheduling. For instance, as illustrated in FIG. 8, a single search space, UL/DD-SS, may be configured within the frequency domain of a CORESET 810. CORESET 810 may include additional search spaces as well (not illustrated). In some aspects, the search space UL/DL-SS may be configured for either uplink scheduling (e.g., DCI format 0_1) or downlink scheduling (e.g., DCI format 1_1).

In some aspects, for a search space UL/DL-SS that may be configured for either uplink or downlink scheduling, as illustrated in FIG. 8, a UE may receive a SS configuration indicating whether UL/DD-SS is configured for uplink or downlink scheduling. In some aspects, a UE may receive a SS configuration in a single communication indicating that UL/DD-SS is configured for one of uplink or downlink scheduling. In some aspects, a UE may receive a SS configuration in multiple communications indicating that UL/DD-SS is configured for one of uplink or downlink scheduling. For instance, a UE may receive a first communication indicating that UL/DD-SS is configured for either uplink or downlink scheduling, and the UE may further receive a second communication indicating that UL/DD-SS is configured for one of uplink or downlink scheduling, where, in some aspects, the second communication may include one of a media access control (MAC) control element (CE), a radio resource control (RRC) message, or a PDCCH in a common search space (CSS).

In some aspects, for a search space UL/DL-SS that may be configured for either uplink or downlink scheduling, as illustrated in FIG. 8, each of a BS and a UE may determine that UL/DL-SS is configured for one of uplink or downlink scheduling based on a rule. For instance, a search space such as UL/DL-SS of FIG. 8 may be associated with a SS ID, and a BS and a UE may determine that UL/DL-SS is configured for one of uplink or downlink scheduling based on a rule where UL/DL-SS is for uplink scheduling (e.g., DCI format 0_1) if its SS ID is even and UL/DL-SS is for downlink scheduling (e.g., DCI format 1_1) if its SS ID is odd (or vice versa). Alternatively, a BS and a UE may determine that UL/DL-SS is for uplink scheduling if its SS ID is below (or above) a given value and for downlink scheduling if its SS ID is above (or below) the given value. Alternatively, a rule for determining whether UL/DL-SS is for uplink for downlink scheduling may include using a function or algorithm (e.g., based on the SS ID or another input parameter) that determines whether one or more search spaces are for either uplink or downlink scheduling.

In some aspects, a search space such as UL/DL-SS of FIG. 8 may be associated with an aggregation level (AL), and a BS and a UE may determine that UL/DL-SS is configured for one of uplink or downlink scheduling based on the AL. For instance, a BS and a UE may determine that UL/DL-SS is configured for one of uplink or downlink scheduling based on whether an AL is odd or even or whether an AL is larger or smaller than a threshold value. In general, a US and a UE may determine that UL/DL-SS is configured for one of uplink or downlink scheduling based on the SS ID and/or the AL configured for the SS. In some aspects, UL/DL-SS may be configured for one of uplink or downlink scheduling dynamically (e.g., UL in one time period and DL in another time period).

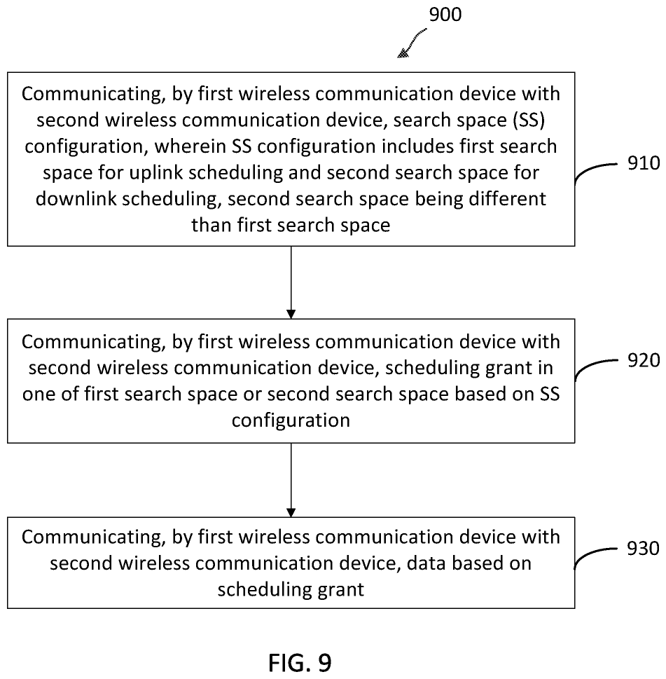

FIG. 9 illustrates a flow diagram of a communication method according to some aspects of the present disclosure. The functionality of method 900 can be executed by a computing device (e.g., a processor, processing circuit, and/or other suitable component) of a wireless communication device or other suitable means. In some aspects, a wireless communication device such as the UE 115 or UE 500 of FIG. 5 may utilize one or more components, such as the processor 502, the memory 404, the SS-Config module 508, the transceiver 510, the modem 512, and the one or more antennas 516, to execute the steps of method 900. Further, a wireless communication device such as the base station (BS) 105 or BS 600 of FIG. 6 may utilize one or more components, such as the processor 602, the memory 604, the SS-Config module 608, the transceiver 610, the modem 612, and the one or more antennas 616, to execute the steps of method 900. The method 900 may employ similar mechanisms as described in FIGS. 1-8 and 10.

As illustrated in FIG. 9, step 910 includes communicating, by first wireless communication device with second wireless communication device, search space (SS) configuration, wherein SS configuration includes first search space for uplink scheduling and second search space for downlink scheduling, second search space being different than first search space. Step 920 further includes communicating, by first wireless communication device with second wireless communication device, scheduling grant in one of first search space or second search space based on SS configuration. Step 930 further includes communicating, by first wireless communication device with second wireless communication device, data based on scheduling grant.

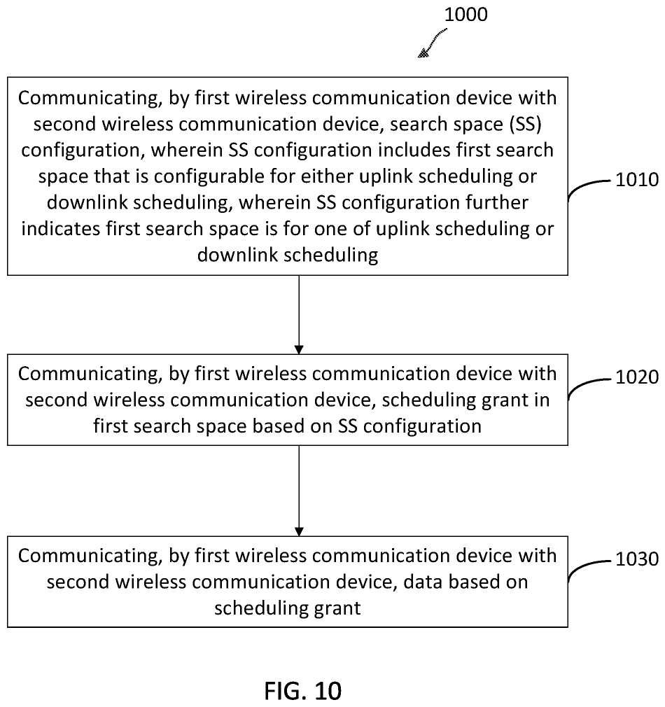

FIG. 10 illustrates a flow diagram of a communication method according to some aspects of the present disclosure. The functionality of method 1000 can be executed by a computing device (e.g., a processor, processing circuit, and/or other suitable component) of a wireless communication device or other suitable means. In some aspects, a wireless communication device such as the UE 115 or UE 500 of FIG. 5 may utilize one or more components, such as the processor 502, the memory 404, the SS-Config module 508, the transceiver 510, the modem 512, and the one or more antennas 516, to execute the steps of method 1000. Further, a wireless communication device such as the base station (BS) 105 or BS 600 of FIG. 6 may utilize one or more components, such as the processor 602, the memory 604, the SS-Config module 608, the transceiver 610, the modem 612, and the one or more antennas 616, to execute the steps of method 1000. The method 1000 may employ similar mechanisms as described in FIGS. 1-9.

As illustrated in FIG. 10, step 1010 includes communicating, by first wireless communication device with second wireless communication device, search space (SS) configuration, wherein SS configuration includes first search space that is configurable for either uplink scheduling or downlink scheduling, wherein SS configuration further indicates first search space is for one of uplink scheduling or downlink scheduling. Step 1020 further includes communicating, by first wireless communication device with second wireless communication device, scheduling grant in first search space based on SS configuration. Step 1030 further includes communicating, by first wireless communication device with second wireless communication device, data based on scheduling grant.

In some instances, the SS configuration includes a UE-specific search space (USS) configuration, the USS configuration including a first field value indicating the first search space is configured for uplink scheduling or a second field value indicating the second search space is configured for downlink scheduling.

In some instances, the SS configuration includes a field, the field including a first field value indicating the first search space is configured for uplink scheduling or a second field value indicating the second search space is configured for downlink scheduling.

In some instances, the second search space for downlink scheduling is additionally for uplink scheduling.

In some instances, the first search space is configured for downlink control information (DCI) format 0_1 and the second search space is configured for DCI format 1_1.

In some instances, the communicating data based on the scheduling grant further comprises: transmitting, by the first wireless communication device to the second wireless communication device, the data on a physical downlink shared channel (PDSCH).

In some instances, the communicating data based on the scheduling grant further comprises: transmitting, by the first wireless communication device to the second wireless communication device, the data on a physical uplink shared channel (PUSCH).

In some instances, the communicating the SS configuration includes: communicating, by the first wireless communication device with the second wireless communication device, a media access control (MAC) control element (CE) indicating the first search space is for one of uplink scheduling or downlink scheduling.

In some instances, the communicating the SS configuration includes: communicating, by the first wireless communication device with the second wireless communication device, a radio resource control (RRC) message indicating the first search space is for one of uplink scheduling or downlink scheduling.

In some instances, the communicating the SS configuration includes: communicating, by the first wireless communication device with the second wireless communication device, a physical downlink control channel (PDCCH) in a common search space (CSS) indicating the first search space is for one of uplink scheduling or downlink scheduling.

In some instances, the method further includes: determining, by the first wireless communication device, that the first search space is for one of uplink scheduling or downlink scheduling based on a rule.

In some instances, the SS configuration includes an aggregation level configuration and the method further comprises: determining, by the first wireless communication device, that the first search space is for one of uplink scheduling or downlink scheduling based on the communicated aggregation level configuration.

In some instances, the first search space is configured for one of downlink control information (DCI) format 0_1 or DCI format 1_1.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

1-16. (canceled)

17. A first wireless communication device, comprising:
a transceiver configured to:
communicate, with a second wireless communication device, a search space (SS) configuration, wherein the SS configuration includes a first search space for uplink scheduling and a second search space for downlink scheduling, the second search space being different than the first search space;
communicate, with the second wireless communication device, a scheduling grant in one of the first search space or the second search space based on the SS configuration; and
communicate, with the second wireless communication device, data based on the scheduling grant.

18. The first wireless communication device of claim 17, wherein the SS configuration includes a UE-specific search space (USS) configuration, the USS configuration including a first field value indicating the first search space is configured for uplink scheduling or a second field value indicating the second search space is configured for downlink scheduling.

19. The first wireless communication device of claim 17, wherein the SS configuration includes a field, the field including a first field value indicating the first search space is configured for uplink scheduling or a second field value indicating the second search space is configured for downlink scheduling.

20. The first wireless communication device of claim 17, wherein the second search space for downlink scheduling is additionally for uplink scheduling.

21. The first wireless communication device of claim 17, wherein the first search space is configured for downlink control information (DCI) format 0_1 and the second search space is configured for DCI format 1_1.

22. The first wireless communication device of claim 17, wherein the transceiver is further configured to:
transmit, to the second wireless communication device, the data on a physical downlink shared channel (PDSCH).

23. The first wireless communication device of claim 17, wherein the transceiver is further configured to:
transmit, to the second wireless communication device, the data on a physical uplink shared channel (PUSCH).

24. A first wireless communication device, comprising:
a transceiver configured to:
communicate, with a second wireless communication device, a search space (SS) configuration, wherein the SS configuration includes a first search space that is configurable for either uplink scheduling or downlink scheduling, wherein the SS configuration further indicates the first search space is for one of uplink scheduling or downlink scheduling;
communicate, with the second wireless communication device, a scheduling grant in the first search space based on the SS configuration; and
communicate, with the second wireless communication device, data based on the scheduling grant.

25. The first wireless communication device of claim 24, wherein the transceiver is further configured to:
communicate, with the second wireless communication device, a media access control (MAC) control element (CE) indicating the first search space is for one of uplink scheduling or downlink scheduling.

26. The first wireless communication device of claim 24, wherein the transceiver is further configured to:
communicate, with the second wireless communication device, a radio resource control (RRC) message indicating the first search space is for one of uplink scheduling or downlink scheduling.

27. The first wireless communication device of claim 24, wherein the transceiver is further configured to:
communicate, with the second wireless communication device, a physical downlink control channel (PDCCH) in a common search space (CSS) indicating the first search space is for one of uplink scheduling or downlink scheduling.

28. The first wireless communication device of claim 24, further comprising:
a processor configured to determine that the first search space is for one of uplink scheduling or downlink scheduling based on a rule.

29. The first wireless communication device of claim 24, wherein the SS configuration includes an aggregation level configuration; and
wherein the first wireless communication device further comprises:
a processor configured to determine that the first search space is for one of uplink scheduling or downlink scheduling based on the communicated aggregation level configuration.

30. The first wireless communication device of claim 24, wherein the first search space is configured for one of downlink control information (DCI) format 0_1 or DCI format 1_1.

31. The first wireless communication device of claim 24, wherein the transceiver is further configured to:
transmit, to the second wireless communication device, the data on a physical downlink shared channel (PDSCH).

32. The first wireless communication device of claim 24, wherein the transceiver is further configured to:
transmit, to the second wireless communication device, the data on a physical uplink shared channel (PUSCH).

33-64. (canceled)
